(19) United States
(12) Patent Application Publication
(10) Pub. No.: US 2015/0347151 A1
(43) Pub. Date: Dec. 3, 2015

(54) SYSTEM AND METHOD FOR BOOTING FROM A NON-VOLATILE MEMORY

(71) Applicant: Diablo Technologies Inc., Ottawa (CA)

(72) Inventors: Michael L. Takefman, Nepean (CA); Bart Trojankowski, Ottawa (CA); Maher Amer, Nepean (CA); Riccardo Badalone, St. Lazare (CA)

(73) Assignee: Diablo Technologies Inc., Ottawa (CA)

(21) Appl. No.: 14/289,547

(22) Filed: May 28, 2014

(51) Int. Cl. G06F 9/44

(52) U.S. Cl. CPC G06F 9/4406

(57) ABSTRACT

A method of booting a computer system using a non-volatile memory of a memory module of the computer system is disclosed. According to one embodiment, a memory controller driver of a memory module of the computer system is stored in a non-volatile memory of the memory module. A memory controller of the memory module has a register that is set to indicate a location of the memory controller driver in the non-volatile memory of the memory module. The memory controller determines the location of the memory controller driver of the memory module using the register. The memory controller driver is transferred from the non-volatile memory to a buffer of the memory controller and subsequently from the buffer of the memory controller to a main memory of the computer system. The computer system initializes the memory module using the memory controller driver.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### RELATED FIELD

The present disclosure relates in general to a technique for loading a driver for a computer system from a memory module, more particularly to a technique for loading the driver from a non-volatile memory of a dual in-line memory module (NVDIMM) or a co-processor input/output (CPIO) device. The present disclosure further relates to a technique to allow an operating system of the computer system to be booted from an NVDIMM or a CPIO device.

### BACKGROUND

Computer systems have different hardware configurations depending on their hardware specification and computing environment. A computer system can boot its operating system (OS) from a variety of hardware components such as a hard disk drive, a USB thumb drive, a solid-state device (SSD), and a network card. A computer system may have a dedicated memory controller that is optimized for a specific type of memory; for example, double data-rate (DDR) dynamic random access memory (DRAM). While the computer system is booting, a firmware of the computer system (e.g., basic input/output system (BIOS)/unified extensible firmware interface (UEFI)) gains an access to a device connected to the computer system using a device driver.

A non-volatile dual in-line memory module (NVDIMM) is a computer memory module that retains data even when electrical power is removed either from an unexpected power loss, system crash or from a normal system shutdown. NVDIMMs may or may not include a DRAM that is accessible by the system and may require a driver to access a non-volatile memory. NVDIMMs improve application performance, data security, recovery time from a system crash and enhanced SSD endurance and reliability. There is a need for booting a computer system from a non-volatile memory of an NVDIMM that resides in a memory channel of the computer system.

### SUMMARY

A method of loading a driver and booting a computer system using a non-volatile memory of a memory module of the computer system is disclosed. According to one embodiment, a memory controller driver of a memory module of the computer system is stored in a non-volatile memory of the memory module. A memory controller of the memory module has a register that is set to indicate a location of the memory controller driver in the non-volatile memory of the memory module. The memory controller runs a state machine during a booting sequence of the computer system and determines the location of the memory controller driver of the memory module using the register. The memory controller driver is transferred from the non-volatile memory to a buffer of the memory controller and subsequently from the buffer of the memory controller into a main memory of the computer system. The computer system initializes the memory module using the memory controller driver. In one embodiment, the computer system uses the memory controller driver to access a non-volatile memory as a part of a normal boot process. In another embodiment, the computer system uses additional registers in the memory controller to boot the computer system using the same path as the memory controller driver is downloaded. Since the memory module driver may access the memory module using the main memory data-path, it is possible to access the memory module in an optimized manner.

According to another embodiment, a computer system comprises a memory module comprising a memory controller and a non-volatile memory, and an interface to access the non-volatile memory. The non-volatile memory of the memory module stores a memory controller driver of the memory module. The memory controller of the memory module comprises a register indicating a location of the memory controller driver and a buffer. The memory controller is configured to determine the location of the memory controller driver of the memory module using the register, and transfer the memory controller driver from the non-volatile memory to the buffer. A firmware of the computer system transfers the memory controller driver from the buffer of the memory controller to a main system memory and initializes the memory module using the memory controller driver.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying drawings, which are included as part of the present specification, illustrate various embodiments and together with the general description given above and the detailed description of the various embodiments given below serve to explain and teach the principles described herein.

FIG. 1 illustrates a block diagram of an exemplary computer system, according to one embodiment;

FIG. 2 illustrates a block diagram of an exemplary bootable NVDIMM storage device that includes a non-volatile memory, according to one embodiment;

FIG. 3 illustrates a block diagram of another exemplary bootable CPIO storage device that includes a non-volatile memory, according to one embodiment;

FIG. 4 illustrates a block diagram of an exemplary bootable NVDIMM storage device that includes a DRAM and a non-volatile memory, according to one embodiment; and

FIG. 5 illustrates a block diagram of another exemplary bootable CPIO storage device that includes a non-volatile memory, according to one embodiment;

FIG. 6 shows an exemplary register map for an NVDIMM controller accessible via an I²C interface, according to one embodiment;

FIG. 7 illustrates exemplary data structures for indicating a list of primary drivers per instruction set, according to one embodiment; and

FIG. 8 gives an exemplary set of operations for BIOS/UEFI, according to one embodiment.

The figures are not necessarily drawn to scale and elements of similar structures or functions are generally represented by like reference numerals for illustrative purposes throughout the figures. The figures show examples of possible implementations of an NVDIMM or CPIO; however the teachings are applicable to other implementations without deviating from the present disclosure. The figures are only intended to facilitate the description of the various embodiments described herein. The figures do not describe every aspect of the teachings disclosed herein and do not limit the scope of the claims.

### DETAILED DESCRIPTION

Each of the features and teachings disclosed herein can be utilized separately or in conjunction with other features and teachings to provide a system and method of booting a computer system from a non-volatile dual in-line memory module (NVDIMM) or a co-processor input/output (CPIO) device. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general-purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but are not intended to limit the dimensions and the shapes shown in the examples.

The present disclosure describes a system and method of accessing and controlling an NVDIMM or a CPIO in order to enable the booting of the computer from the NVDIMM or the CPIO device by downloading a driver from the NVDIMM or the CPIO device itself.

The present disclosure relates in general to techniques for accessing an NVDIMM or a CPIO device on a computer system such that the computer can boot from the NVDIMM or the CPIO device. NVDIMMs may be constructed with a combination of dynamic random access memory (DRAM) and a non-volatile memory, or a non-volatile memory alone. The term NVDIMM herein is used to refer to an NVDIMM, a CPIO device, or a combination thereof.

According to one embodiment, a computer system uses the system management bus (SMBUS) or inter-integrated circuit (I²C) bus to access a primary module driver via a basic input/output system (BIOS)/unified extensible firmware interface (UEFI). It is noted that the terms SMBUS and I²C are herein interchangeably used to designate a bus that is used to access a primary module driver. Depending on the system configuration, either SMBUS or I²C, or both SMBUS and I²C may be used to access the primary module driver. The primary module driver is a minimized driver that allows the BIOS/UEFI to configure the NVDIMM and accesses a non-volatile memory of the NVDIMM such that the operating system image can be retrieved through the DRAM channel. According to another embodiment, the primary module driver accesses the operating system image through the SMBUS. According to yet another embodiment, the primary module driver is located in a serial presence detect (SPD) EEPROM. According to yet another embodiment, a field in the SPD directs the BIOS/UEFI to access an application-specific integrated circuit (ASIC) that is located on the NVDIMM and provides a set of control and data registers that allows the BIOS/UEFI to access the primary module driver from another non-volatile memory on the NVDIMM. Multiple primary module driver images may be stored to provide different processor instruction sets or to provide in-field upgrade and downgrade of the boot loader. When multiple images are available, another set of registers in the memory controller provides a table of the images available.

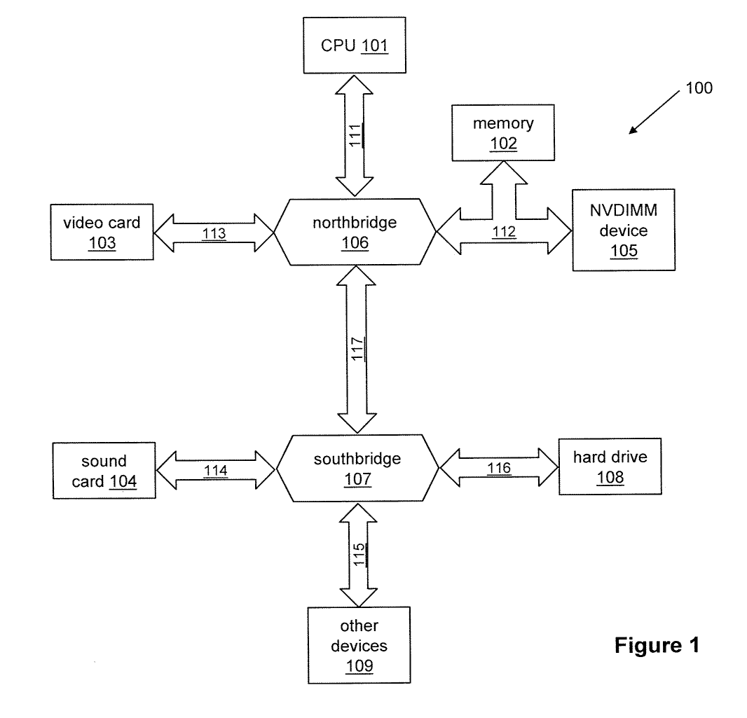

FIG. 1 illustrates a block diagram of an exemplary computer system according to one embodiment. A computer system 100 includes a central processing unit (CPU) 101, a main memory unit (e.g., DRAM) 102, and CPIO devices including a video card 103, a sound card 104, a hard drive 108, and any generic CPIO device 105. These components are connected together via buses on a motherboard (not shown). The CPU 101, the main memory unit 102, and the video card 103 are connected to a northbridge 106 via a front-side bus (FSB) 111, a main memory bus 112, and a peripheral component interconnect express (PCIe) bus 113, respectively. The northbridge 106 generally refers to a chip in a chipset of the motherboard that connects a high-speed bus.

Slower buses, including the PCI bus 114, a universal serial bus (USB) 115, and a serial advanced technology attachment (SATA) bus 116 are usually connected to a southbridge 107. The southbridge 107 generally refers to another chip in the chipset that is connected to the northbridge 106 via a direct media interface (DMI) bus 117. The southbridge 107 manages the information traffic between CPIO devices that are connected via a low-speed bus. For example, the sound card 104 typically connects to the computer system 100 via the PCI bus 114. Storage drives, such as the hard drive 108, typically connect to the computer system 100 via the SATA bus 116. A variety of other devices 109, ranging from a keyboard to an mp3 music player, may connect to the system 100 via the USB 115.

Similar to the main memory unit 102 (e.g., DRAM), the generic CPIO device 105 connects to a memory controller in the northbridge 106 via the main memory bus 112. For example, the generic CPIO device 105 may be inserted into a dual in-line memory module (DIMM) memory slot. Because the main memory bus 112 generally supports higher bandwidths (e.g., compared to the SATA bus 116), the exemplary computer system of FIG. 1 connecting the generic CPIO device 105 to the main memory bus eliminates or alleviates I/O bottlenecks that would otherwise limit the I/O performance of the generic CPIO device 105.

Although each of the block components is shown in FIG. 1 as a discrete component, it is contemplated that some of the components may be combined or integrated with one or more other components. For example, the CPUs produced by INTEL® may include a northbridge or a southbridge as a part of the CPU.

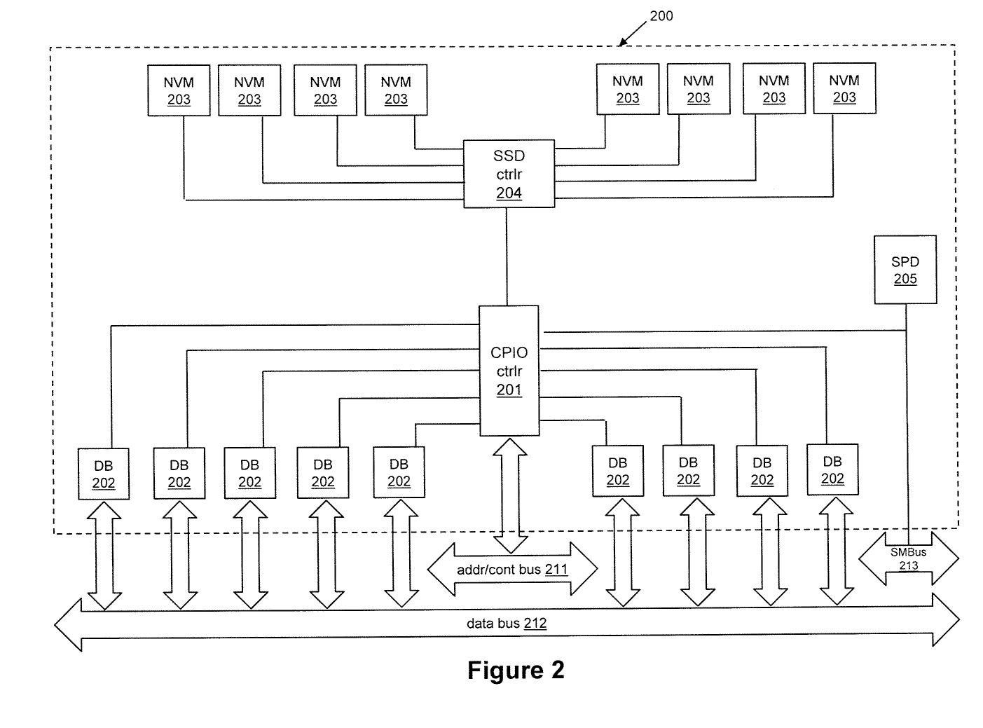

An NVDIMM or a CPIO device may include various components to be compatible with an unbuffered DIMM (UDIMM), a registered DIMM (RDIMM), or a load-reduced DIMM (LRDIMM). FIGS. 2-5 illustrate various DIMM arrangements that allow DIMMs of various types to be constructed. Common to all of these arrangements is an SMBUS that connects the central processing unit (CPU) to the serial presence detect (SPD) and the controller ASIC of the NVDIMM/CPIO. In another embodiment, inter-integrated circuit (I²C) protocol or Serial Peripheral Interface (SPI) may be employed for communication between the controller ASIC and a non-volatile memory (e.g., NVM, SPD, and BIOS/UEFI image). In another embodiment, a SATA, Serial Attached SCSI (SAS) or PCIe interface may be employed for communications between the controller ASIC and a Solid State Disk (SSD). In another embodiment, the controller ASIC could directly control flash or other non-volatile memory.

Although DIMMs shown in FIGS. 2-5 implement an NVDIMM, the present teachings are applicable to any other function that would require a driver to access any variations of DIMMs. A CPIO device may include any device, and it is understood that the term CPIO herein also refers to any co-processor or I/O device in addition to an NVDIMM. According to one embodiment, a CPIO device receives and processes data from a host computer system. The received data may be stored, modified by the CPIO device, and/or used by the CPIO device to generate new data, wherein the stored, modified, and/or new data is sent back to the host computer system.

FIG. 2 illustrates a block diagram of an exemplary bootable NVDIMM storage device that includes a non-volatile memory, according to one embodiment. The CPIO storage device 200 is configured to interface to a computer system's main memory controller and includes a NVDIMM/CPIO controller 201, a number of re-timers 202, a rank of non-volatile memory (NVM) devices 203, an SSD controller 204, and a serial presence detect (SPD) 205.

The NVDIMM/CPIO controller 201 provides a memory-mapped interface so that a software driver can control the NVDIMM/CPIO storage device 200. The NVDIMM/CPIO controller 201 also includes control circuitry for the re-timers 202 and an interface (e.g., SATA, SAS and PCIe) to the SSD controller 204. The SPD 205 stores information about the NVDIMM/CPIO storage device 200, such as its size (e.g., number of ranks of memory), data width, manufacturer, speed, and voltage and may be accessed via a system management bus (SMBus) 213. The SSD controller 204 manages the operations of the NVM devices 203, such as accessing (e.g., reading, writing, erasing) the data in the NVM devices 203. The NVDIMM/CPIO storage device 200 connects to the computer system's address/control bus 211 and main memory bus 212 via the NVDIMM/CPIO controller 201.

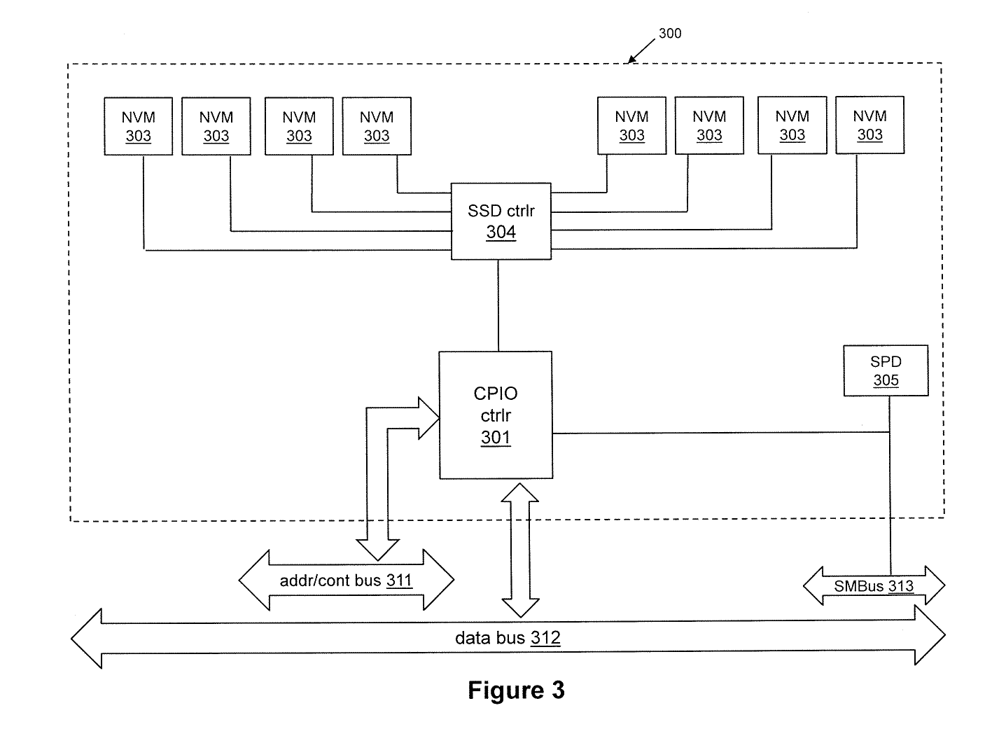

In this embodiment, the data buffer devices 203 buffer the connection between the CPIO storage device's (200) on-DIMM memory bus and the main memory bus 212. According to one embodiment, such as the embodiment illustrated by FIG. 3, the on-DIMM memory bus may connect directly to the main memory bus 212 without going through data buffer devices. Because the NVDIMM/CPIO storage device 200 does not include a rank of DRAM devices, it provides more room for NVM devices.

The BIOS is a set of firmware instructions that is run by the computer system to set up the hardware and to boot into an operating system when it first powers on. After the computer system powers on, the BIOS accesses the SPD 205 via the SMBus 213 to determine the memory organization in the NVDIMM/CPIO storage device 200. Using this memory organization information, BIOS trains the DDR memory channel to enable communications with the DIMM(s). In cases when having access to the memory in the NVDIMM/CPIO ASIC is insufficient, a primary module driver is used to properly control the memory module.

FIG. 3 illustrates a block diagram of another exemplary bootable CPIO storage device that includes a non-volatile memory, according to one embodiment. The CPIO storage device 300 is configured to interface to a computer system's main memory controller and includes a CPIO controller 301, NVM devices 303, an SSD controller 304, and an SPD 305. The CPIO storage device 300 connects to the computer system's address/control bus 311 and main memory bus 312 via the CPIO controller 301. The CPIO storage devices (300) on-DIMM memory bus connects the CPIO controller 301 directly to the main memory bus 312.

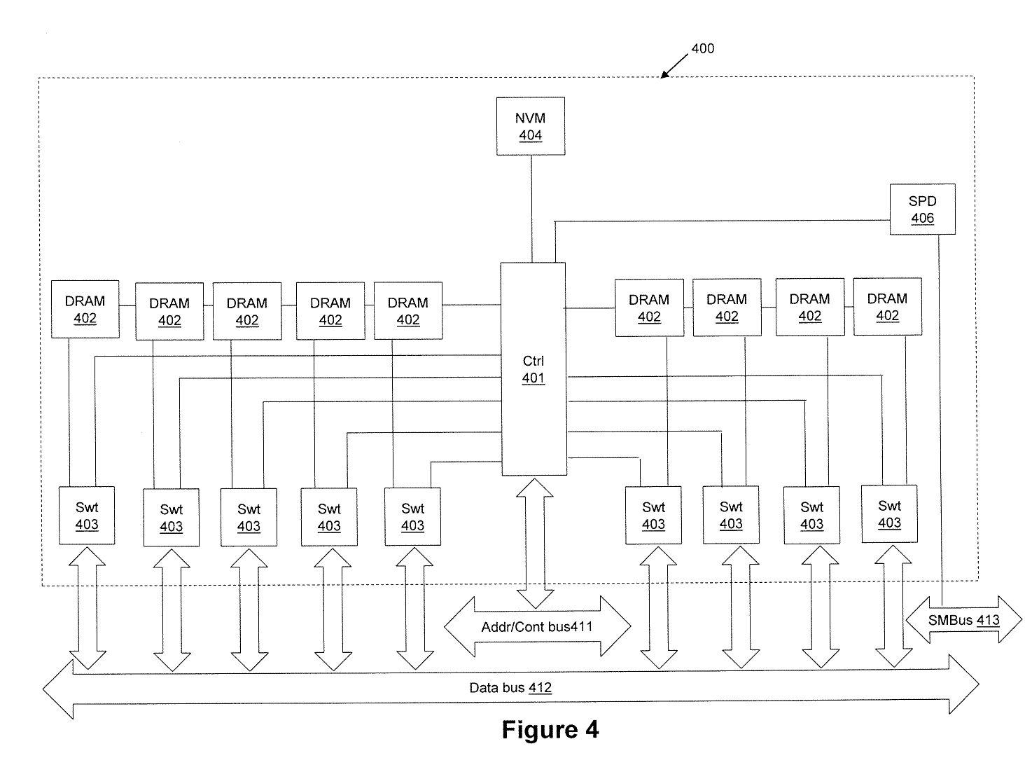

FIG. 4 illustrates a block diagram of an exemplary bootable NVDIMM storage device that includes a DRAM and a non-volatile memory according to one embodiment. The NVDIMM DIMM 400 includes an NVDIMM controller 401, a rank of DRAM devices 402, a number of switches 403, an NVM device 404, and an SPD 406. The NVDIMM controller 401 manages the flow of data going to and from the NVM device 404. The address/control bus 411 is connected to the controller 401 while the main memory bus 412 is separated from the on-DIMM memory bus by the re-timers 403. FIG. 4 represents an integration of an RPLL device and a non-volatile memory controller to create an RDIMM variant.

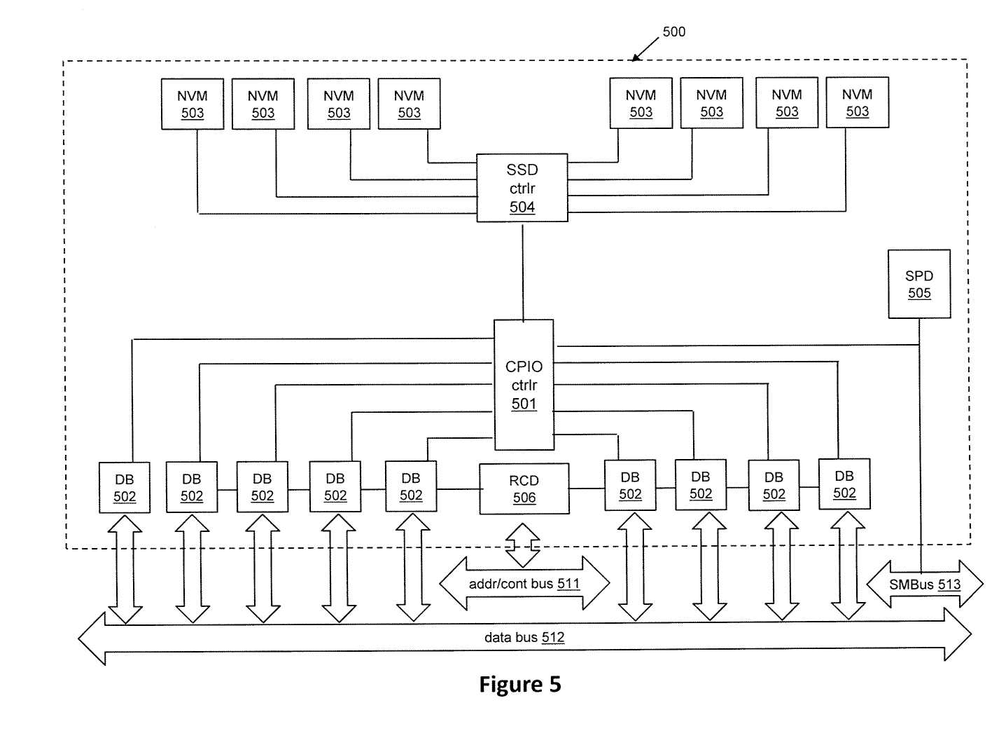

FIG. 5 illustrates a block diagram of another exemplary bootable CPIO storage device that includes a non-volatile memory, according to one embodiment. The CPIO DIMM 500 includes a CPIO controller 501, a DDR-4 Register Control Device (RCD) 506, a number of re-timers 502, a rank of NVM devices 503, an SSD controller 504, and an SPD 505. In another embodiment, the CPIO controller 501 may also include control circuitry for the re-timers 502 and an interface (e.g., SATA, PCI-E, etc.) to the SSD controller 504. The SSD controller 504 manages the flow of data going to and from the NVM devices 503. It is contemplated that the functions of the SSD controller 504 may be integrated into the CPIO controller 501. The address/control bus 511 is connected to the CPIO controller 501 while the main memory bus 512 is separated from the on-DIMM memory bus by the re-timers 502.

An NVDIMM or a CPIO device may require a software driver to configure the NVDIMM/CPIO and access a non-volatile memory (e.g., SPD 205, 305, 405, 505, NVM 203, 303, 404, and 504) of FIGS. 2-5. Because different software drivers are required for different devices made by different manufacturers, it would be expensive and difficult for BIOS/UEFI to include all of the software drivers in the BIOS/UEFI image. As such, a primary-driver can be designed such that it provides sufficient capabilities to configure and access the NVDIMM/CPIO. The BIOS/UEFI can then use the primary driver to access the OS boot-loader stored in the non-volatile memory of the NVDIMM/CPIO.

According to one embodiment, the computer system reads data stored in the SPD via the SMBUS. Traditionally, 256 or 512 bytes of data (which are contained in an SPD) are used by the BIOS/UEFI to identify configuration information about the DIMM. A size of a typical operating system is typically far too large to fit into the SPD. A primary driver may be too large to fit into the SPD, although a much larger SPD could be sufficient.

In cases when the primary driver is too large to fit into the SPD, the SMBUS provides an access method to the memory controller of the NVDIMM that does not require a DDR channel path that is operational. Referring to FIGS. 2-5, SPD 205, 305, 405 and 505 are connected to the corresponding CPIO controller 201, 301, 401 and 501, respectively. In one embodiment, a set of registers and a state machine within the NVDIMM ASIC provide an access to read the primary driver out of a non-volatile memory device other than an SPD.

In one embodiment, the non-volatile memory device is a bulk non-volatile storage. In another embodiment, the non-volatile memory device is a separate non-volatile chip (i.e., a serial NOR flash). The SMBUS interface provides read and/or write data in various sizes (e.g., 8-bit, 16-bit, and 32-bit). A single register write may provide sufficient information to instruct the NVDIMM ASIC to begin to transfer the primary driver from the non-volatile memory to a buffer in the NVDIMM ASIC. The BIOS/UEFI reads the buffer of the NVDIMM ASIC. After reading the primary driver, BIOS/UEFI initializes the NVDIMMs and begins to access the “boot” NVDIMM to get the operating system boot loader.

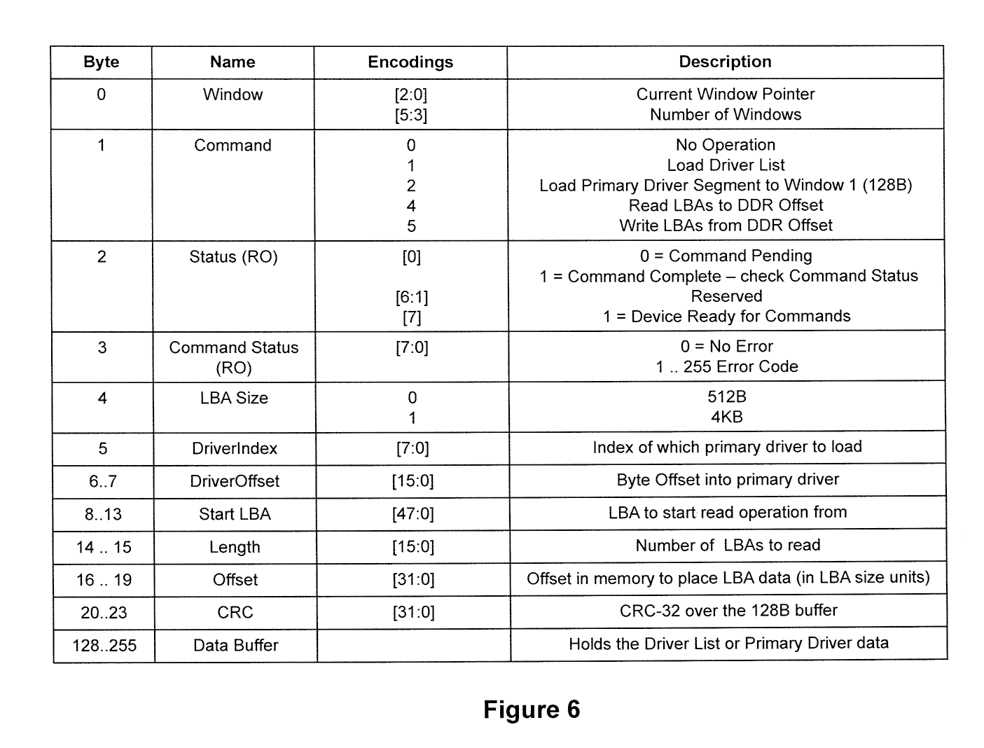

In one embodiment, an I²C interface (similar to the SPD) is used to connect to the NVDIMM ASIC. In the following examples with reference to FIGS. 6-8, an I²C has 256 directly accessible bytes. However, it is noted that an I²C interface can have a different size of directly accessible bytes without deviating from the scope of the present disclosure. According to one embodiment, a windowing scheme is used to allow the primary driver to be read in a burst smaller than 256 bytes. Control registers would handle fetching the next N bytes.

FIG. 6 shows an exemplary register map for an NVDIMM controller accessible via an I²C interface, according to one embodiment. The register map includes a number of different control/status registers and a 128-byte data space to hold a portion of a primary driver. Byte 0 indicates a current window pointer and the number of windows. Byte 1 of the register map specifies five commands. The number of commands may be expanded as needed. The first two commands (i.e., Load Driver Table, Load Primary Driver) are sufficient to allow a download of the primary driver over the I²C interface. The next two commands provide a basic method for UEFI to load or store data to the non-volatile memory (e.g., in a block format) from the memory that is accessible via the DDR interface. It is noted that for some NVDIMMs, the primary driver must be run even in the cases when the I²C interface is used in order to configure the DDR channel of the NVDIMM ASIC correctly. Bytes 2, 3, 4, 5, 6 and 7 respectively indicate a status, command status, logical block addressing (LBA) size, driver index and driver offset. Bytes 8 to 13 indicate start LBAs from which a read/write operation is started. Bytes 14 to 15 indicate the number of LBAs to read/write. Bytes 16 to 19 indicate the offset in memory to write/read the LBA data. Bytes 20 to 23 indicate a cyclic redundancy check (CRC) over the 128-byte buffer. Finally, Bytes 128 to 255 are data buffers that hold the drive list or primary driver data.

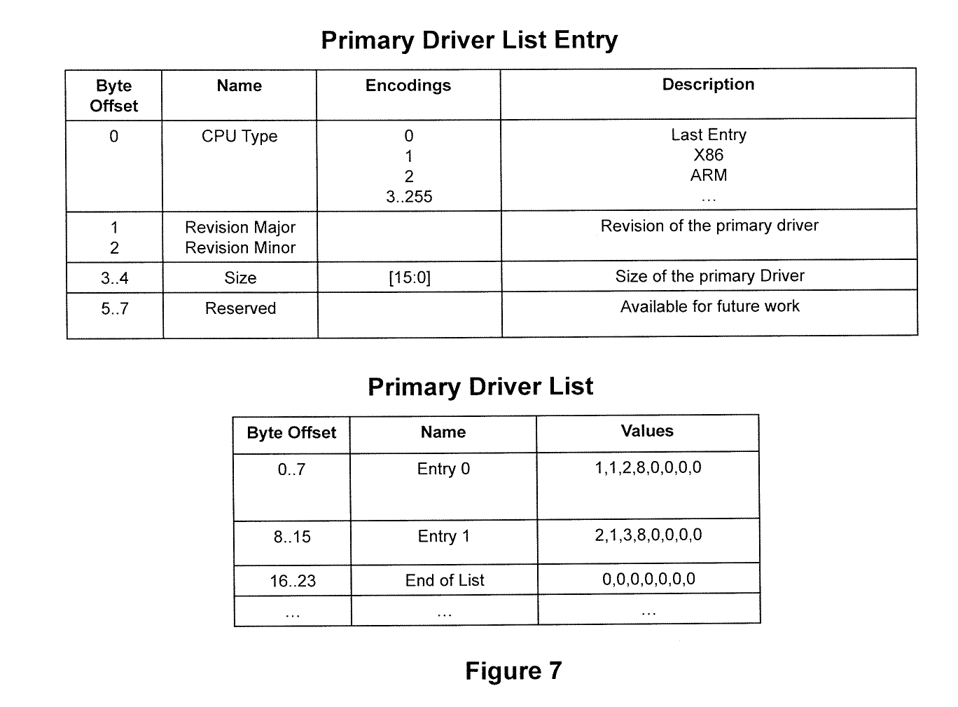

FIG. 7 illustrates exemplary data structures for indicating a list of primary drivers per instruction set, according to one embodiment. An array of exemplary data structure of each entry of a primary driver list forms the primary driver list. Byte 0 of the primary driver list entry indicates the CPU type. Bytes 1 and 2 of the primary driver list entry indicate the revision of the primary driver. Bytes 3 and 4 of the primary driver list entry indicate the size of the primary driver. Bytes 5, 6, and 7 are reserved for future use.

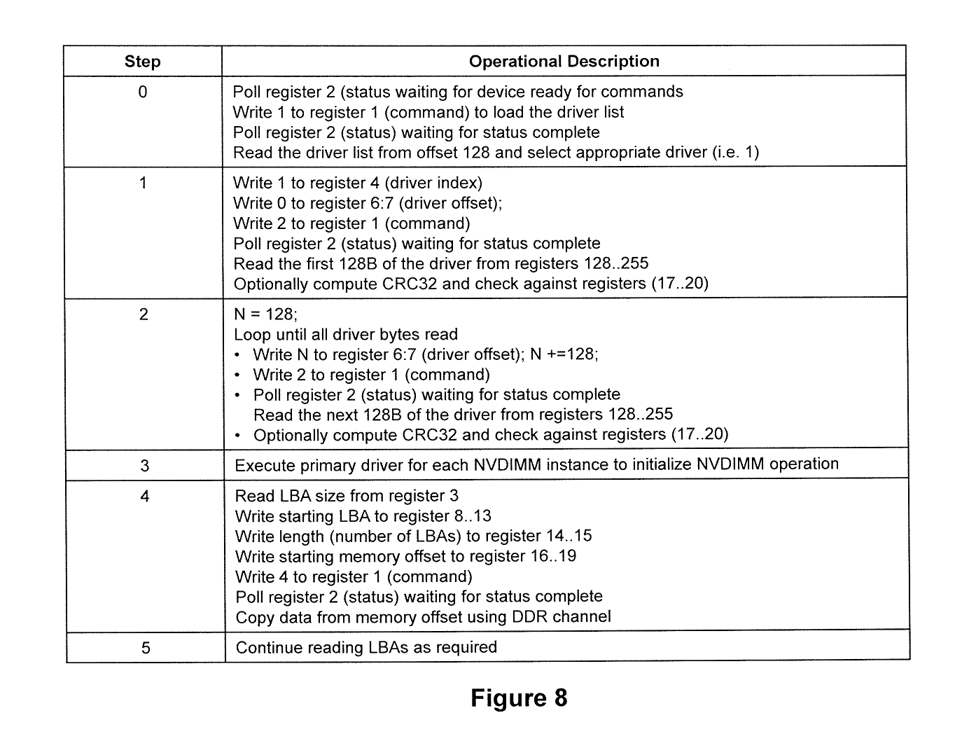

FIG. 8 gives an exemplary set of operations for BIOS/UEFI, according to one embodiment. A set of operations for BIOS/UEFI is used to access the NVDIMM controller, load the primary driver, and read the boot loader using the LBA (block) interface. It is noted that once the primary driver is executing, it is also possible for BIOS/UEFI to load the boot loader via the driver and not use the I²C again.

In step 0, the memory controller polls register 2 (status register) and waits for device ready for commands (bit 7==1). The memory controller writes 1 to register 1 (command register) to load a primary driver list, and waits for status complete by polling registers 2 and 3 (status register 2 bit 0==1 and command status register==0). Once the primary driver list is loaded, the memory controller reads the primary driver list from offset 128 (optionally computing CRC32 and checking against registers 20 to 23) and selects an appropriate driver.

In step 1, the memory controller writes 1 to register 4 (driver index) and writes 0 to registers 6 and 7 (in order to access the first 128 bytes of the driver) and writes 2 to register 1 (command register) to begin operation. After waiting for status complete by polling registers 2 and 3 (status registers), the memory controller reads the first 128 bytes of the primary driver from registers 128 to 255, and optionally computes CRC32 and checks against registers 20 to 23.

In step 2, the memory controller loops until all driver bytes are read by a) writing the next offset to registers 6 and 7 (incrementing the offset by 128), b) writing 2 to register 1 (command register), c) polling registers 2 and 3 (status registers) to wait for status complete and read the next 128 bytes of the primary driver from registers 128 to 255, and d) optionally computing CRC32 and check against registers 20 and 23.

In step 3, the memory controller executes the primary driver for each NVDIMM instance to initialize the NVDIMM operation. In step 4, the memory controller reads LBA size from register 3, writes starting LBA to registers 8 to 13, writes starting memory offset to registers 16 to 19, writes a length (in LBA size units) to registers 14 and 15, and executes a command to run the primary driver by writing 3 to register 1 (command register). After waiting for status complete by polling register 2 (status register), the memory controller copies data from the memory offset using a DDR channel. In step 6, the memory controller continues to read LBAs as required. It should be obvious to one ordinarily skilled in the art that the same control mechanism can be used for causing a write operation from the memory buffer to the non-volatile memory.

The access to the operating system boot loader via the SMBUS/I²C may be too slow. According to one embodiment, the present system uses a DDR channel to access the operating system boot loader. Access to the operating system boot loader via a DDR channel achieves a faster booting time. According to one embodiment, the present system provides multiple primary driver images including a number of different processor instructions sets that are programmed into the NVDIMM ASIC. Controller registers of the NVDIMM ASIC are used to select an appropriate primary driver image.

The above example embodiments have been described hereinabove to illustrate various embodiments of implementing a system and method of booting a computer system from a non-volatile memory. Various modifications and departures from the disclosed example embodiments will occur to those having ordinary skill in the art. The subject matter that is intended to be within the scope of the present disclosure is set forth in the following claims.

We claim:

1. A method for booting a computer system, the method comprising:
storing a memory controller driver of a memory module of the computer system in a non-volatile memory of the memory module, wherein the memory module has a memory controller;
setting a register of the memory controller to indicate a location of the memory controller driver in the non-volatile memory of the memory module;
determining the location of the memory controller driver of the memory module using the register;
transferring the memory controller driver from the non-volatile memory to a buffer of the memory controller;
transferring the memory controller driver from the buffer of the memory controller to a main memory of the computer system; and
initializing the memory module using the memory controller driver.

2. The method of claim 1, wherein a firmware of the computer system accesses the buffer of the memory controller and initializes the memory module using the memory controller driver.

3. The method of claim 1, wherein the memory controller driver contains memory configuration information of the memory module.

4. The method of claim 1, wherein the memory controller driver is a primary driver.

5. The method of claim 1, wherein the non-volatile memory is a bulk storage.

6. The method of claim 1, wherein the non-volatile memory is a NOR flash memory.

7. The method of claim 1, wherein the non-volatile memory is a serial presence detect (SPD) chip.

8. The method of claim 1, wherein the memory controller driver is transferred from the non-volatile memory to the buffer of the memory controller over a system management bus (SMBUS).

9. The method of claim 1, wherein the memory controller driver is transferred from the non-volatile memory to the buffer of the memory controller over an I²C bus.

10. The method of claim 1, wherein a firmware of the computer system accesses the memory module over a DDR channel.

11. The method of claim 1, wherein the non-volatile memory of the memory module stores a plurality of driver images of the computer system.

12. The method of claim 11, wherein a plurality of controller registers of the memory controller has a plurality of registers to select an appropriate driver image from the plurality of driver images.

13. A computer system comprising:
a memory module comprising a memory controller and a non-volatile memory;
a main memory;
an interface to access the non-volatile memory,
wherein the non-volatile memory of the memory module stores a memory controller driver of the memory module,
wherein the memory controller of the memory module comprises a register indicating a location of the memory controller driver and a buffer,
wherein the memory controller is configured to:
a) determine the location of the memory controller driver of the memory module using the register,
b) transfer the memory controller driver from the non-volatile memory to the buffer of the memory controller via the interface, and
wherein the computer system transfers the memory controller driver from the buffer of the memory controller to the main memory of the computer system, and initializes the memory module using the memory controller driver.

14. The computer system of claim 13, wherein a firmware of the computer system accesses the buffer of the memory controller and initializes the memory module.

15. The computer system of claim 13, wherein the memory controller driver contains memory configuration information of the memory module.

16. The computer system of claim 13, wherein the non-volatile memory is a NOR flash memory.

17. The computer system of claim 13, wherein the non-volatile memory is a serial presence detect (SPD) chip.

18. The computer system of claim 13, wherein the memory controller driver is transferred from the non-volatile memory to the buffer of the memory controller over a system management bus (SMBUS).

19. The computer system of claim 13, wherein the memory controller driver is transferred from the non-volatile memory to the buffer of the memory controller over an I²C bus.

20. The computer system of claim 13, wherein the non-volatile memory of the memory module stores a plurality of driver images of the computer system.

21. The computer system of claim 20, wherein a plurality of controller registers of the memory controller has a plurality of registers to select an appropriate driver image from the plurality of driver images.
